(19) United States
(12) Patent Application Publication
(10) Pub. No.: US 2013/0196148 A1
(43) Pub. Date: Aug. 1, 2013

(54) SYNTHETIC ACRYLIC MARBLE HAVING PEARL-CONTAINING PATTERNS AND METHOD OF PRODUCING THE SAME

(71) Applicant: Sang Ho Shin, Chungeheongbuk-do (KR)

(72) Inventor: Sang Ho Shin, Chungeheongbuk-do (KR)

(73) Assignee: LG HAUSYS, LTD., Seoul (KR)

(21) Appl. No.: 13/876,094

(22) PCT Filed: Oct. 18, 2011
(86) PCT No.: PCT/KR2011/007761

§ 371 Date: Mar. 26, 2013

(30) Foreign Application Priority Data
Oct. 19, 2010 (KR) 10-2010-0101887

(51) Int. Cl. C04B 30/00; B29C 45/00

(52) U.S. Cl. CPC C04B 30/00; B29C 45/0001
USPC 428/338; 428/221; 264/162

(57) ABSTRACT

Synthetic acrylic marble including a pearl-containing pattern which is produced by kneading two or more compounds with different colors, and adding a pearl pigment thereto and thus exhibits natural pearl pattern effects, thus obtaining appearance having a natural and luxurious pearl pattern as compared to conventional synthetic marbles.

### TECHNICAL FIELD

The present invention relates to a synthetic acrylic marble having a pearl-containing pattern and a method for producing the same. More specifically, the present invention relates to a synthetic acrylic marble having a pearl-containing pattern which is produced by kneading two or more compounds with different colors, and adding a pearl pigment thereto, and thus exhibits natural pearl pattern effects, thus obtaining natural and luxurious appearance as compared to conventional synthetic marbles using chips containing a pearl pigment and a method for producing the same.

### BACKGROUND ART

In general, synthetic marbles produced from an acrylic resin are widely used for counter tables and a variety of interior materials owing to advantages of beautiful appearance and superior processability as well as lightness and superior strength as compared to natural marbles. However, there is a technical limitation in realizing a variety of patterns through commonly known combination of chips with single colors, as compared to natural marbles or granite stones.

Synthetic acrylic marbles are generally produced by mixing a syrup containing a mixture of a monomer such as methyl methacrylate and polymethyl methacrylate, with an inorganic filler such as aluminum hydroxide, calcium carbonate or silica, and an additive such as a pigment, a hardener, an initiator, a release agent or a dispersant, and casting the mixture into a mold and a continuous steel belt, followed by hardening.

At this time, pigments and chips are used to realize the desired shape and color, the main components of chips are the same as synthetic marbles, and chips having a variety of colors and particle sizes are produced in the same process as synthetic marbles by incorporating a pigment with a single color, followed by crushing.

Conventional methods for obtaining pearl effects by incorporating pearl include incorporating a pearl pigment into chips to prepare chips, followed by crushing and casting. This method has a limitation in which the pearl pigment is present only within the chips. That is, there is a limitation in preparing chips evenly distributed throughout the overall surface of synthetic marbles. When the chips are evenly distributed throughout the overall surface thereof, they are present on only one of the front and back surfaces due to difference in specific gravity and there is thus a technical limitation in reproducing natural patterns.

### DISCLOSURE OF INVENTION

### Technical Problem

Therefore, the present invention has been made in view of the problems and it is one object of the present invention to provide a synthetic marble which solves drawbacks of conventional synthetic marbles which are prepared by incorporating pearl patterns into chips and thus exhibit monotonous and artificial sensations as compared to natural marbles, and overcomes limitation of the color and pattern realized by chips with a single color, thus realizing luxurious appearance owing to natural pearl patterns, unlike conventional synthetic marbles.

It is another object of the present invention to provide a method for the synthetic marble having a natural and luxurious pearl pattern.

The objects above and other objects can be accomplished by the present invention.

### Solution to Problem

Accordingly, in accordance with one aspect of the present invention, provided is a synthetic acrylic marble in which a pearl pattern is naturally distributed.

In accordance with another aspect of the present invention, provided is a method for preparing a synthetic acrylic marble comprising: (a) kneading a synthetic marble liquid material; (b) incorporating the kneaded liquid material, an inorganic filler and a chip into a kneader to obtain two or more sheets; (c) kneading the sheets in separate kneaders; (d) adding a pearl pigment to the kneaded material, followed by kneading to obtain a sheet-form compound; and (e) injecting the sheet-form pearl pattern compound into a die, followed by molding, removal of the die, cooling and polishing.

### Advantageous Effects of Invention

As can be seen from FIGS. 1 and 2, the present invention provides a synthetic acrylic marble having a pearl-containing pattern which is produced by kneading two or more compounds with different colors, and adding a pearl pigment thereto, and thus exhibits natural pearl pattern effects, thus obtaining natural and luxurious pearl pattern effects as compared to conventional synthetic marbles using chips containing a pearl pigment.

### BRIEF DESCRIPTION OF DRAWINGS

The above and other objects, features and other advantages of the present invention will be more clearly understood from the following detailed description taken in conjunction with the accompanying drawings, in which:

FIG. 1 shows a synthetic marble panel containing a pearl pattern according to one embodiment of the present invention;

FIG. 2 shows a synthetic marble panel containing a pearl pattern according to one embodiment of the present invention; and

FIG. 3 is a flow chart illustrating a method for preparing the synthetic acrylic marble according to the present invention.

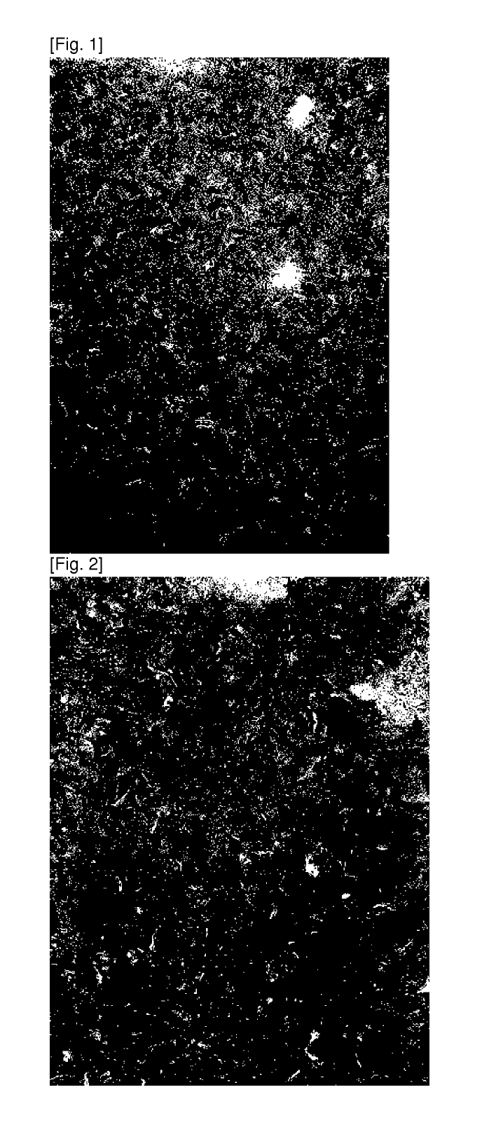

### BEST MODE FOR CARRYING OUT THE INVENTION

Hereinafter, the present invention will be described in more detail.

The present invention provides a synthetic acrylic marble having a pearl-containing pattern using a pearl pigment which comprises: two or more compounds containing: a liquid material consisting of 50 to 700 parts by weight of an inorganic filler, 0.2 to 5 parts by weight of a cross-linking agent, and 0.2 to 3 parts by weight of a crosslinking accelerator based on 100 parts by weight of an acrylic resin syrup; an inorganic filler; and a chip; and 0.1 to 100 parts by weight of a pearl pigment, based on 100 parts by weight of the liquid material.

The liquid material preferably has a viscosity of 5,000 to 100,000 Ps.

The particle size of pearl pigment which constitutes the pearl pattern is preferably 0.1 to 100 microns.

In addition, the present invention provides a method for preparing a synthetic acrylic marble including: (a) kneading a synthetic marble liquid material; (b) incorporating the kneaded liquid material, an inorganic filler and a chip into a kneader to obtain two or more sheets; (c) kneading the two or more sheets in separate kneaders; (d) adding a pearl pigment to the kneaded material, followed by kneading to obtain a sheet-form compound; and (e) injecting the sheet-form pearl pattern compound into a die, followed by molding, removal of the die, cooling and polishing.

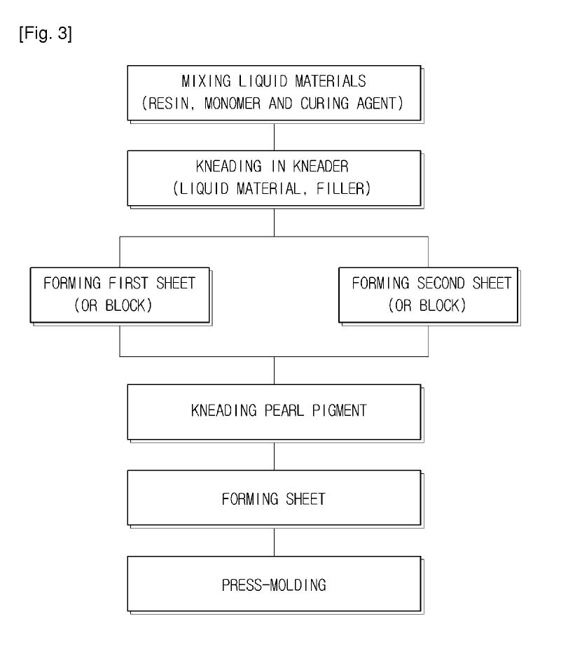

The method for preparing synthetic acrylic marble is shown in FIG. 3.

The reason for kneading the liquid material in the first step (a) of the method is to increase an viscosity of materials in order to realize an optimum pattern during press-molding, and the reason for forming sheets in step (b) of the method is to make molding easy by charging the compound into a die.

The synthetic marble liquid material in step (a) comprises 50 to 700 parts by weight of an inorganic filler, 0.2 to 5 parts by weight of a cross-linking agent, and 0.2 to 3 parts by weight of a crosslinking accelerator, based on 100 parts by weight of an acrylic resin syrup consisting of 10 to 50% by weight of an acrylic resin and 50 to 90% by weight of an acrylic monomer.

The liquid material in step (a) preferably has a viscosity of 5,000 to 100,000 Ps. The viscosity of liquid material of conventional methods in which synthetic acrylic marbles are produced by casting is 30 to 200 Ps, while the production method of the synthetic acrylic marble according to the present invention utilizes a liquid material which has a viscosity ranging from 5,000 to 100,000 Ps, enabling a pearl pattern to realize natural and luxurious appearance. When the viscosity is lower than 5,000 Ps, kneading is excessive and natural pattern is not formed. When the viscosity exceeds 100,000 Ps, disadvantageously, mixing is excessively insufficient and the appearance is unnatural.

In step (b), preferably, the inorganic filler is used in an amount of 200 to 500 parts by weight and the chip is used in an amount of 0 to 300 parts by weight, more preferably, 50 to 200 parts by weight, based on 100 parts by weight of the liquid material.

In addition, in step (d), the pearl pigment is used in an amount of 0.1 to 100 parts by weight, based on 100 parts by weight of the liquid material. Disadvantageously, when the content of pearl pigment is lower than 0.1 parts by weight, pearl effects are insufficient and when the content exceeds 100 parts by weight, appearance is not luxurious.

The polymerizable monomer of acrylic resin syrup used for the present invention is preferably an acrylic monomer. Specifically, the acrylic resin syrup is a methacrylate monomer selected from methyl methacrylate, ethyl methacrylate, butyl methacrylate, 2-ethylhexyl methacrylate, benzyl methacrylate and glycidyl methacrylate, a mixture thereof, a mixture thereof, or a mixture of the methacrylate monomer and a polymer partially polymerized therefrom. Of these, methyl methacrylate is particularly preferred. The content of polymer in the syrup is preferably 10 to 50% by weight.

The inorganic filler used for the present invention may be any of inorganic powders commonly used in the art such as aluminum hydroxide, magnesium hydroxide, calcium aluminate, calcium carbonate, a silica powder, and alumina, and may be used alone or in combination thereof. Preferably, the inorganic filler has a particle size of 3 to 200 μm and has a surface treated with a silane-based coupling agent, a titanate-based coupling agent or stearic acid in order to improve dispersability with a resin and mechanical strength of products and prevent precipitation. Preferably, the content of the inorganic filler is 200 to 500 parts by weight with respect to 100 parts by weight of the resin.

When the content of the inorganic filler is lower than 200 parts by weight, kneading is excessive due to low viscosity and natural patterns are not formed, and when the content exceeds 500 parts by weight, mixing is excessively poor and patterns are not natural.

The cross-linking agent used for the present invention is a multifunctional acrylic monomer which contains double bonds which can be copolymerized in molecules and be cross-linked to the acrylic resin syrup, and examples thereof include ethylene glycol dimethacrylate, diethylene glycol dimethacrylate, triethylene glycol dimethacrylate, tetraethylene glycol dimethacrylate, trimethylol propane trimethacrylate, 1,6-hexanediol dimethacrylate, polybutylene glycol dimethacrylate, neopentyl glycol dimethacrylate and mixtures thereof. Of these, ethylene glycol dimethacrylate is particularly preferred.

When the cross-linking agent is not used or used in an excessively small amount, roughness is formed on the surface, bonding strength between components is deteriorated, for example, foams are generated in upper and lower portions of synthetic marbles, and heat resistance and heat-resisting discoloration are deteriorated. When the cross-linking agent is excessively used, chips are phase-separated and synthetic marble patterns have a variety of problems. Accordingly, the amount of cross-linking agent used is preferably 0.2 to 5 parts by weight with respect to 100 parts by weight of the resin syrup.

The crosslinking accelerator used for the present invention is organic peroxide and is one or a mixture of two or more selected from the group consisting of organic peroxides including diacyl peroxides, such as benzoyl peroxide and dicumyl peroxide, hydroperoxides, such as butyl hydroperoxide and cumyl hydroperoxide, t-butyl peroxy maleic acid, t-butyl hydroperoxide, t-butyl hydroperoxy butylate, acetyl peroxide, lauroyl peroxide, azobisisobutyronitrile, azobisdimetylvaleronitrile, t-butyl peroxy-neodecanoate, and t-amylperoxy-2-ethylhexanoate. Further, the resin syrup may be polymerized and hardened at the room temperature using a mixture of peroxide of amine and sulfuric acid or a mixture of peroxide and cobalt compound. The content of crosslinking accelerator is preferably 0.2 to 3 parts by weight based on 100 parts by weight of the resin syrup and the crosslinking accelerator is generally used in combination with a polymerization accelerator.

When the content of cross-linking agent is lower than 0.2, molding time is lengthened and production efficiency is thus deteriorated, and when the content exceeds 3 parts by weight, cracks may be formed due to rapid hardening.

In addition, a radical carrier such as mercaptan compounds including n-dodecyl mercaptan, t-dodecyl mercaptan, benzyl mercaptan and trimethyl benzyl mercaptan may be used. Preferably, the content of the radical carrier is 0.1 to 5 parts by weight based on 100 parts by weight of the resin syrup.

A coloring material used for the present invention is not particularly limited and is selected from commonly used synthetic marbles such as organic or inorganic pigments or dyes.

The composition may further comprise at least one additive selected from the group consisting of commonly known additives for synthetic marbles including silicon or non-silicon antifoaming agents; silane coupling agents containing trimethoxy silane as a main component, or acid or titanate coupling agents; organic or inorganic pigments or dyes; phenyl salicylate, benzophenone, benzotriazole, nickel derivative or radical scavenger ultraviolet absorbing agents; halogen, phosphorous or inorganic metal flame- retardants; stearic acid or silicon releasing agents; catechol or hydroquinone polymerization inhibitors; and phenol-, amine-, quinine-, sulfur- or phosphorous-based antioxidants.

In step (f), the molding pressure is 5 to 50 kg/cm², and molding temperature is 30 to 150° C. When the molding pressure is lower than 5 kg/cm², molding is not performed and when the molding pressure exceeds 50 kg/cm², the amount of burr is excessive.

More various marble patterns can be produced by forming three or more sheets in the same method, followed by molding, in order to realize three or more marble effects.

Hereinafter, preferred examples of the present invention will be described for better understanding, but are provided only for illustrative purposes, those skilled in the art will appreciate that various modifications, additions and substitutions are possible, without departing from the scope and spirit of the invention as disclosed in the accompanying claims.

### EXAMPLE

1. Production of Single Color Sheet

(1) Preparation of Raw Materials

0.3 parts by weight of a pigment was mixed with a raw material slurry containing 100 parts by weight of a methyl methacrylate syrup containing a mixture of 30% by weight of polymethyl methacrylate and 70% by weight of methyl methacrylate, 400 parts by weight of aluminum hydroxide, 0.2 parts by weight of t-butyl peroxy deodecanoate, 0.3 parts by weight of t-amyl peroxy 2-ethyl hexanoate, 3 parts by weight of ethylene glycol dimethacrylate, 0.2 parts by weight of normal dodecyl mercaptan, 0.2 parts by weight of BYK 555 (BYK-Chemie GmbH, Germany) as an antifoaming agent, 0.75 parts by weight of BYK 900 (BYK-Chemie GmbH, Germany) as a coupling agent, and 0.2 parts by weight of Hisorp-P (LG Chem., Ltd.) as a UV stabilizer (absorber) to prepare a resin pigment composition with a single color.

(2) Preparation of Single Color Sheet

The resin pigment composition with a single color (viscosity 1,000 cps) was further added to a kneader containing 400 parts by weight of aluminum hydroxide and 200 parts by weight of chips through a supply line, followed by kneading for about 20 minutes.

After kneading, the blown bulk material was formed into the form of a sheet using a plate.

(3) Production of Pearl Pattern Sheet

Another sheet was produced in the same process using a different color pigment, and two sheets having a predetermined shape and a weight were then kneaded in separate kneaders for about 10 seconds, to realize marble patterns in which two chip patterns are mixed. One part by weight of a pearl pigment (copper ash, Charmscience, Korea) was added to the marble pattern-provided bulk compound, followed by kneading and blowing to produce a sheet having a width of 760 t, a length of 3680 t, and a thickness of 14 t.

2. Production of Synthetic Marble

The sheet-form pearl pattern compound was injected into a die pre-heated at a temperature of 120° C. and molded at a pressure of 15 kg/cm², and the die was removed, followed by cooling and sanding to produce a synthetic marble containing a natural pearl pattern.

1. A synthetic acrylic marble having a pearl-containing pattern comprising:
two or more compounds containing: a liquid material consisting of 50 to 700 parts by weight of an inorganic filler, 0.2 to 5 parts by weight of a cross-linking agent, and 0.2 to 3 parts by weight of a crosslinking accelerator, based on 100 parts by weight of an acrylic resin syrup; an inorganic filler; and a chip; and
0.1 to 100 parts by weight of a pearl pigment, based on 100 parts by weight of the liquid material.

2. The synthetic acrylic marble according to claim 1, wherein the liquid material has a viscosity of 5,000 to 100,000 Ps.

3. The synthetic acrylic marble according to claim 1, wherein the pearl pigment forming the pearl pattern has a particle size of 0.1 to 100 microns.

4. The synthetic acrylic marble according to claim 1, wherein the acrylic resin syrup comprises 10 to 50% by weight of an acrylic resin and 50 to 90% by weight of an acrylic monomer.

5. The synthetic acrylic marble according to claim 4, wherein the acrylic monomer is selected from the group consisting of methyl methacrylate, ethyl methacrylate, butyl methacrylate, 2-ethyl hexyl methacrylate, benzyl methacrylate, glycidyl methacrylate and mixtures thereof, and the acrylic resin is at least one polymer of the acrylic monomer.

6. The synthetic acrylic marble according to claim 1, wherein the inorganic filler is selected from the group consisting of aluminum hydroxide, magnesium hydroxide, calcium aluminate, calcium carbonate, a silica powder, alumina and combinations thereof.

7. The synthetic acrylic marble according to claim 1, wherein the cross-linking agent is selected from the group consisting of ethylene glycol dimethacrylate, diethylene glycol dimethacrylate, triethylene glycol dimethacrylate, tetraethylene glycol dimethacrylate, trimethylol propane trimethacrylate, 1,6-hexanediol dimethacrylate, polybutylene glycol dimethacrylate, neopentyl glycol dimethacrylate and combinations thereof.

8. The synthetic acrylic marble according to claim 1, wherein the crosslinking accelerator is selected from the group consisting of benzoyl peroxide, dicumyl peroxide, butyl hydroperoxide, cumyl hydroperoxide, t-butyl peroxy maleic acid, t-butyl hydroperoxide, t-butyl hydro peroxy butylate, acetyl peroxide, lauroyl peroxide, azobisisobutyronitrile, azobisdimethylvaleronitrile and t-butyl peroxy deodecanoate, t-amyl peroxy 2-ethyl hexanoate and combinations thereof.

9. A method for producing a synthetic acrylic marble comprising:
(a) kneading a synthetic marble liquid material;
(b) incorporating the kneaded liquid material, an inorganic filler and a chip into a kneader to obtain two or more sheets;
(c) kneading the sheets in separate kneaders;
(d) adding a pearl pigment to the kneaded material, followed by kneading to obtain a sheet-form compound; and
(e) injecting the sheet-form pearl pattern compound into a die, followed by molding, removal of the die, cooling and polishing.

10. The method according to claim 9, wherein the synthetic marble liquid material in step (a) comprises 50 to 700 parts by weight of an inorganic filler, 0.2 to 5 parts by weight of a cross-linking agent, and 0.2 to 3 parts by weight of a crosslinking accelerator, based on 100 parts by weight of an acrylic resin syrup consisting of 10 to 50% by weight of an acrylic resin and 50 to 90% by weight of an acrylic monomer.

11. The method according to claim 9, wherein the liquid material in step (a) has a viscosity of 5,000 to 100,000 Ps.

12. The method according to claim 9, wherein the acrylic monomer is selected from the group consisting of methyl methacrylate, ethyl methacrylate, butyl methacrylate, 2-ethyl hexyl methacrylate, benzyl methacrylate, glycidyl methacrylate and mixtures thereof, and the acrylic resin is at least one polymer of the acrylic monomer.

13. The method according to claim 9, wherein the inorganic filler is selected from the group consisting of aluminum hydroxide, magnesium hydroxide, calcium aluminate, calcium carbonate, a silica powder, alumina and combinations thereof.

14. The method according to claim 9, wherein the cross-linking agent is selected from the group consisting of ethylene glycol dimethacrylate, diethylene glycol dimethacrylate, triethylene glycol dimethacrylate, tetraethylene glycol dimethacrylate, trimethylol propane trimethacrylate, 1,6-hexanediol dimethacrylate, polybutylene glycol dimethacrylate, neopentyl glycol dimethacrylate and combinations thereof.

15. The method according to claim 9, wherein the crosslinking accelerator is selected from the group consisting of benzoyl peroxide, dicumyl peroxide, butyl hydroperoxide, cumyl hydroperoxide, t-butyl peroxy maleic acid, t-butyl hydroperoxide, t-butyl hydro peroxybutylate, acetyl peroxide, lauroyl peroxide, azobisisobutyronitrile, azobisdimethyl-valeronitrile and t-butyl peroxy deodecanoate, t-amyl peroxy 2-ethyl hexanoate and combinations thereof.

16. The method according to claim 9, wherein in step (b), the inorganic filler is present in an amount of 200 to 500 parts by weight and the chip is present in an amount of 0 to 300 parts by weight, based on 100 parts by weight of the liquid material.

17. The method according to claim 9, wherein, in step (d), the pearl pigment is used in an amount of 0.1 to 100 parts by weight, based on 100 parts by weight of the liquid material.

18. The method according to claim 9, wherein, in step (e), the molding pressure is 5 to 50 kg/cm2, and the molding temperature is 30 to 150° C.
